(19) United States
(12) Patent Application Publication
(10) Pub. No.: US 2014/0114916 A1
(43) Pub. Date: Apr. 24, 2014

(54) CODE GENERATION AND IMPLEMENTATION METHOD, SYSTEM, AND STORAGE MEDIUM FOR DELIVERING BIDIRECTIONAL DATA AGGREGATION AND UPDATES

(71) Applicants: Pamela Szabo, Houston, TX (US); Michael Guillory, Houston, TX (US); Sharath Reddy Putta, Houston, TX (US)

(72) Inventors: Pamela Szabo, Houston, TX (US); Michael Guillory, Houston, TX (US); Sharath Reddy Putta, Houston, TX (US)

(21) Appl. No.: 14/124,525

(22) PCT Filed: Jun. 6, 2012
(86) PCT No.: PCT/US12/41142

§ 371 Date: Dec. 6, 2013

Related U.S. Application Data
(60) Provisional application No. 61/493,955, filed on Jun. 6, 2011.

(51) Int. Cl. G06F 17/30

(52) U.S. Cl. CPC G06F 17/30289
USPC 707/616

(57) ABSTRACT

Embodiments are provided for delivering aggregated data from disparate systems (e.g. CRM, databases, etc.), making the data available to another system or end user with the functionality to read, create, update, and/or delete the source data. The disclosed subject matter provides a way to deliver bi-directional aggregated information from independent and potentially disparate systems as if the information came from a single system without the need for any interim data store. Additionally, the disclosed subject matter creates the instructions necessary for making the aggregated data available to other systems and end users in various modes of interaction (e.g. ADO.Net, SharePoint®, web services, etc.). Further, an end user awareness is employed that carries source-specific authorization checks before any data access or updates. The disclosed subject matter therefore can access aggregated data from multiple sources and propagate changes made back to the original source systems.

### FIELD OF THE INVENTION

The invention relates to the aggregation of data from one or more potentially disparate systems while enabling bi-directional information transfer (e.g. read and/or write capability) without interim staging of the data.

### BACKGROUND OF THE INVENTION

With the rise in demands for business analytics, key performance indicators, and interaction across internet-based software as a service, the end user has an increasing need to access and interact with data directly from multiple sources, often merged together in a single screen. Meanwhile, the demand for near-real time delivery of this type of information to applications and end users is also rapidly increasing.

For example, many commercially available software packages used in today's marketplace include web services, database systems (e.g. SQL, Oracle® (a registered trademark of Oracle International Corporation), MySQL, etc.), customer relationship management (“CRM”) software (e.g. Salesforce® (a registered trademark of Salesforce.com, Inc.), PeopleSoft® (a registered trademark of Oracle International Corporation), Microsoft® Dynamics CRM (a registered trademark of Microsoft Corporation), etc.), and collaboration and document management systems (e.g. SharePoint® (a registered trademark of Microsoft Corporation), HyperOffice® (a registered trademark of Application Corporation), Google® Apps (a registered trademark of Google, Inc.), etc.), and electronic instruments (e.g. RFID, medical instruments, OCR devices, etc.). Other data is stored in text files, spreadsheets, and XML files. The foregoing, and other similar systems are referred to herein as “disparate systems,” “systems,” and/or “sources”. However, the vast majority of disparate systems are not configured to work together. If a user needs some information from more than one of these systems, the user is forced to start each system and perform independent queries to obtain the needed information. This is time consuming, confusing, and incredibly inefficient.

Currently, it is a huge task for a company to implement a data aggregation system that is capable of retrieving data from multiple potentially disparate sources and populating and/or making it available to another system. First a domain expert, who is an expert in the specific data source, must review and understand the schema of the source data. This domain expert must then provide the schema information to a developer. The developer would have to then create objects (e.g. classes) based on the schema information. Next the developer would have to engineer/develop ways to connect to the source system's data. The developer then would have to create a data layer and construct an object relational mapping layer. Finally, the developer would create logic to push the data to a destination database, application, delivery queue, or other physical destination for the data. Note that the above steps must be done for each data source. If the data sources are not compatible or just slightly different (e.g. disparate) the above steps are repeated for each such data source/system. Additionally, if any part of the source data schema changes, the process must be restarted.

Historically, the way to make data from disparate systems available to an application or end user was to move all of the data to a database or data warehouse. The application or user would query the data store when the data was needed. This approach is problematic, because the data is often out-of-date (e.g. stale) and because it is impossible to write back directly live when there is a staging data store in the middle.

More recent advances have been made wherein a developer programs the conversion of data from each of multiple sources to XML, before they are merged together; however, this is problematic because of the programming time to write the conversion and because the output is XML. Therefore, because the data is only in XML, the data may be consumed only by applications which can use XML, usually via a web service call.

While some mapping and transformation engines exist and there is some knowledge of generating simple write-back maps, there is no known way to automatically generate the packaging and mechanism to make CRUD (create, read, write, delete) capabilities available in various delivery modes (e.g. SharePoint®, web service, ADO.Net, etc.) without significant programming.

All of the aforementioned approaches to data aggregation pose at least one of many impediments to providing actionable near real time data to the consuming application with awareness and access security specific to the end user. These impediments include: long implementations; significant custom programming; inability to adapt to new sources or new types of consuming applications; necessity to make in-memory or physical copies of the data as the data is being processed, which poses security risks and impacts performance; severe latency due to intermediate XML format conversion steps, which means the end user or application may not be acting on the latest information; limitation where consuming packaging is web services only; restriction to read-only data access, eliminating the possibility of writing back to the sources; inability to access and merge/align more than one source at a time; inability to generate multiple forms of packaging, which reduces the re-usability of the destination data schema, a feature that is particularly important in uses such as Master Data definition and management; and lack of end-user-awareness where some mechanism of end user security restricts the ability to read, create, update, or delete with respect to each of the sources.

In view of the above shortcomings, and others that will become apparent, there is a need for an improved data aggregation system.

### BRIEF SUMMARY OF THE INVENTION

The disclosed subject matter provides methods, systems, and computer readable storage mediums to provide an intuitive graphical user interface for applying a mapping from multiple disparate sources (e.g., software packages/systems/databases/web services/electronic instruments, etc.) to a virtual table and make it available for pro-active access from endpoint applications through packaging in one or more modes ((e.g. ADO.NET, SharePoint®, Web Services, etc.) to provide a single point of access to the endpoint application or its user.

It is an object of the disclosed subject matter to permit read and write access to multiple disparate systems in a single interface.

Yet another object of the disclosed subject matter is to generate instructions (e.g. connection string, XML, web service) to implement the bi-directional access to the disparate systems for use in multiple environments (e.g. ADO.NET, SharePoint®, Web Services, etc.).

Still another object of the disclosed subject matter is to provide customizable filtering of data.

An additional object of the disclosed subject matter is to provide data aggregation with bi-directional access without needing an intermediate data store.

An additional object of the disclosed subject matter is to provide data aggregation with bi-directional access without the user needing any programming expertise or experience.

Yet another object of the disclosed subject matter is to provide actionable near real time data to the consuming application with awareness and access security specific to the end user.

Still another object of the disclosed subject matter is to provide the ability to adapt to new sources or new types of consuming applications.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of any claims filed later. Although many objects/aspects for the disclosed subject matter are provided above, a particular embodiment need not contain all of the objects/aspects.

### BRIEF DESCRIPTIONS OF THE DRAWINGS

The novel features believed characteristic of the disclosed subject matter will be set forth in any claims filed later. The disclosed subject matter itself, however, as well as a preferred mode of use, further objectives, and advantages thereof, will best be understood by reference to the following detailed description of illustrative embodiments when read in conjunction with the accompanying drawings, wherein:

FIG. 1 depicts an overall block diagram of one embodiment of the disclosed subject matter.

FIG. 2 depicts a diagram of the three layers of metadata of one embodiment of the disclosed subject matter.

FIGS. 3a and 3b depict exemplary embodiments of Operational metadata according to the disclosed subject matter.

FIG. 4 depicts a screenshot of the main interface of an embodiment according to the disclosed subject matter.

FIGS. 5a through 5d depict screenshots of an embodiment of several input boxes (select map, add association, connection string, and add filter) reached from the main interface according to the disclosed subject matter.

FIG. 6 depicts a block diagram for implementing the disclosed subject matter for ADO.Net according to a particular embodiment of the disclosed subject matter.

FIG. 7 depicts a block diagram for implementing the disclosed subject matter for web services according to a particular embodiment of the disclosed subject matter.

FIG. 8 depicts a block diagram for implementing the disclosed subject matter for SharePoint® according to a particular embodiment of the disclosed subject matter.

FIG. 9 depicts a block diagram of an integration platform that interacts with the disclosed subject matter according to a particular embodiment.

In the figures, like elements should be understood to represent like elements, even though reference labels may be omitted on some instances of a repeated element, for simplicity.

### DETAILED DESCRIPTION OF ILLUSTRATIVE EMBODIMENTS

Although described with particular reference to ADO.Net, SharePoint®, and web services, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

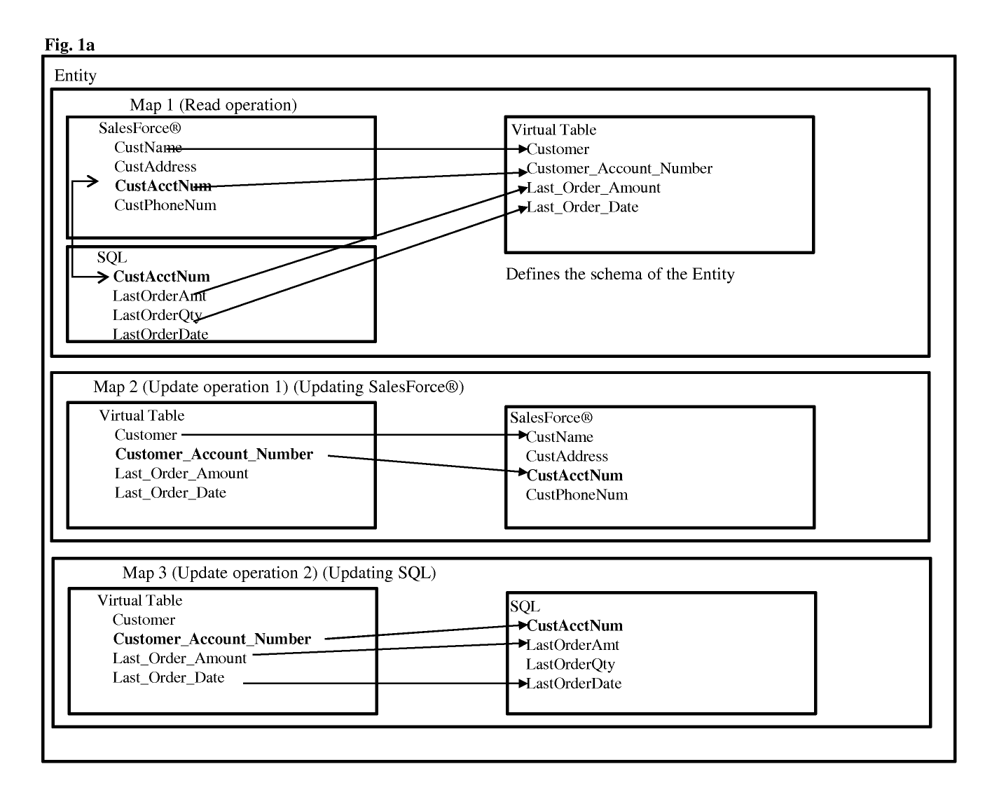

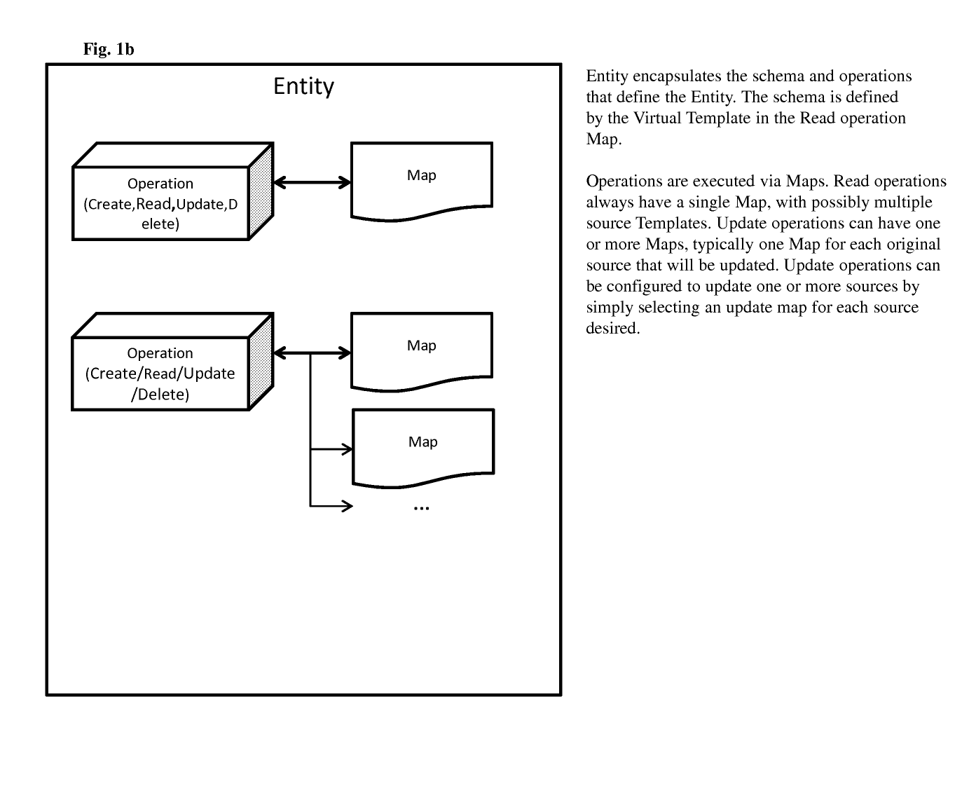

FIG. 1 depicts an overall block diagram of one embodiment of the disclosed subject matter. There is a design-time module 72 which is used to select and configure the parameters of the disclosed subject matter, and which generates information called metadata as well as generating executable components corresponding to the configuration metadata. The second module is the runtime module 84 that executes and interacts with an existing integration platform. Referring first to 72, design-time, EMS UI 76 interacts with 78 metadata from the existing integration platform and 74 generates metadata instructions 80 for the runtime module 84. Once a configuration is completed, and the desired delivery mode is established, the Packaging Generator 82 of the Design module 72 accordingly generates the appropriate run-time executable package 84 to deliver the on-demand data aggregation and updates in the specific modes desired. For example, these modes may be as ADO.Net Driver, a Web Service, or a Custom Connector for SharePoint® BCS. Each runtime module 84 is designed specifically for the requesting endpoint mode, and includes the particular wrapper and packaging required to interface with that endpoint mode. Depending upon the requesting endpoint, a separate module may be required to be installed on the endpoint's client or server or the integration platform's server.

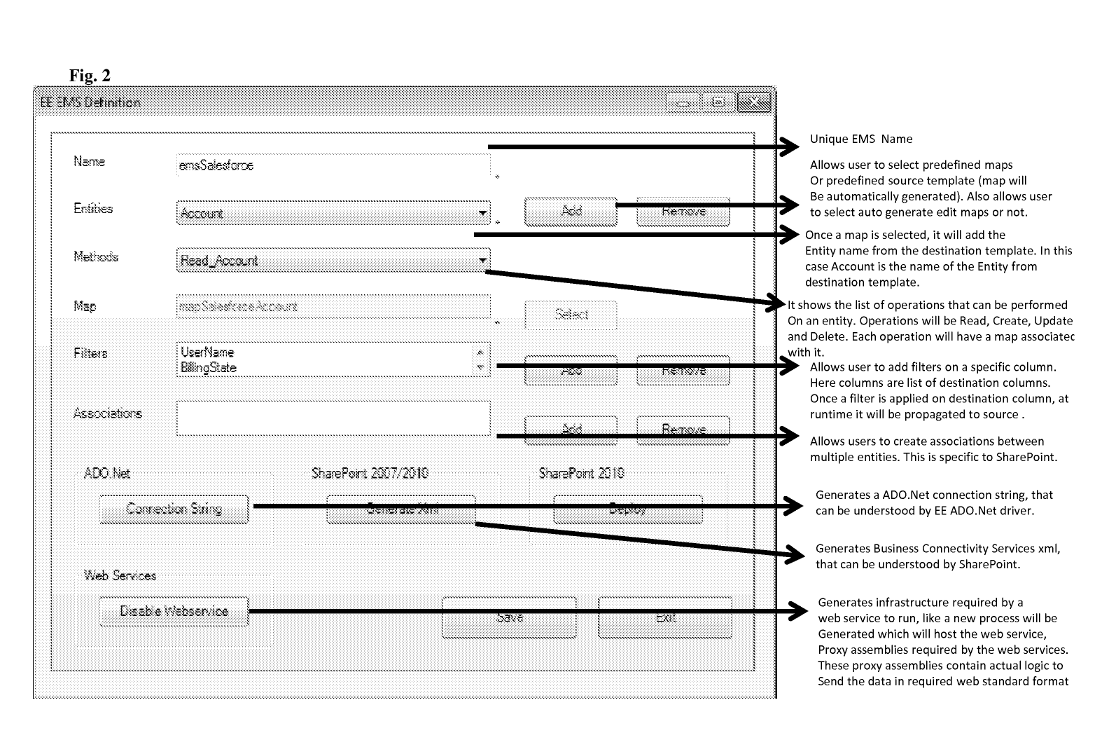

Generally speaking, an integration platform is driven by metadata that the integration platform generates for specific uses and executes when needed. Referring to FIG. 2, container 90 is depicted with three layers of metadata which describe a stack wherein each layer includes the lower layer by reference. Operation metadata 92 is generated by an integration platform and includes associations between one or more sources of data and a destination for the data. For example, the Operation metadata could be broken into three regions: the source, the mapping or transformation, and the destination. The source containing the fields available in the source system, represented by a metadata template for each system. The virtual schema, or table, may contain the fields the user wants displayed in the destination program. Finally, the map provides the logical association between the sources and destination, which is also represented by a metadata template. Since the destination for the purpose of this embodiment is not a physical endpoint (e.g., application, database, etc.), it is referred to here as “virtual.” The Operation metadata of 92 constitute one of many possibilities of how the metadata may be defined in the underlying integration platform. Here, a “map” means the information necessary for an integration platform to execute specific data integration from one or more sources to a destination and encapsulating source endpoint access knowledge. A map represents “Operation metadata” which describes READ and for bi-directional operations, WRITE, UPDATE or DELETE operations according to the integration platform.

An Entity 94 encapsulates the virtual schema and one or more operations that define that Entity. Entity metadata adds to the Operation metadata the instructions for data filtering that may be exercised by the end user, and settings for use of end user security such as SSS, Claims, and Active Directory. Further, it includes special handling instructions, for example, retrieval limit settings and caching settings. On top of the Entity metadata is the Container metadata 96 which defines the instructions for packaging of one or more selected Entities so that the data can be requested in various ways. Those with skill in the arts will recognize that there are many other options that could be configured as part of the Container, Entity, and Operation metadata as instructions to the packaging or execution of the data delivery. The disclosed subject matter describes generating Entity 94 and Container 96 metadata, and executing said metadata instructions system, while Operation Metadata 92 is defined and executed by a separate integration platform.

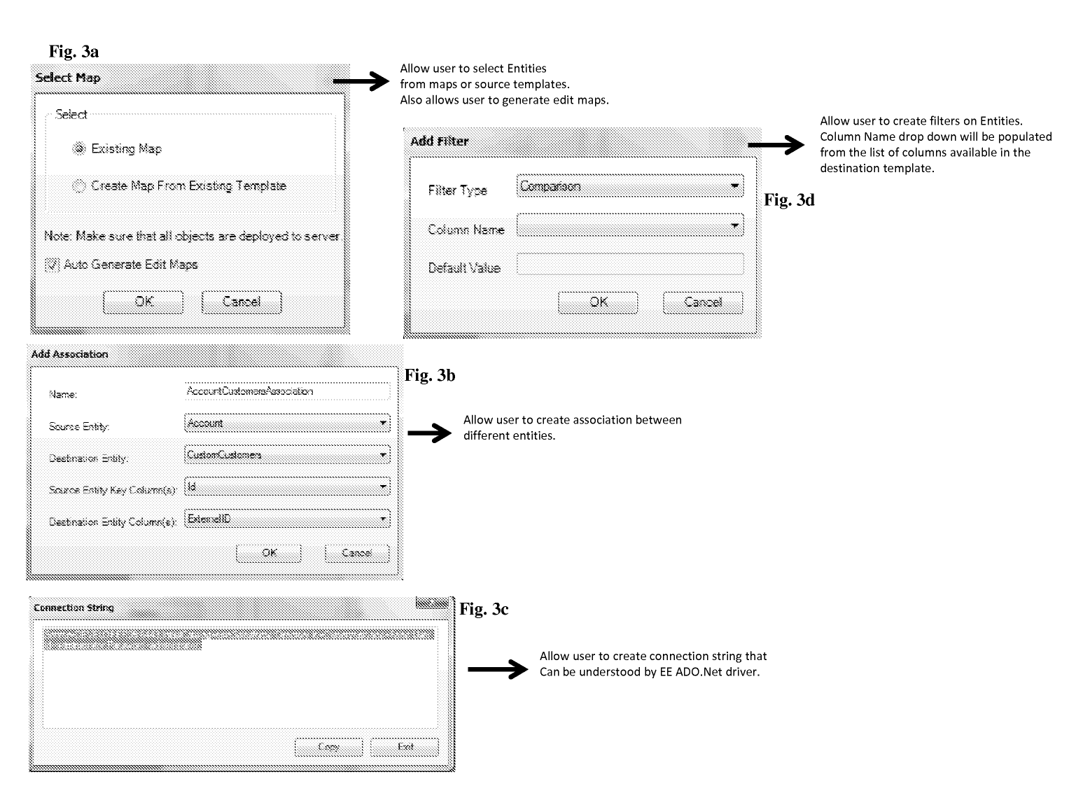

To more clearly explain, particular embodiments of Operational metadata are provided in FIGS. 3a and 3b. Referring first to FIG. 3a, this particular Operation metadata contains three maps: Map1 102 (read operation) here reading from Salesforce and SQL at the same time and mapping to the Virtual Table, Map2 104 (update operation 1—updating SalesForce®), and Map3 106 (update operation 2—updating SQL). Map1 102 contains two sources: SalesForce® and a SQL table. Map2 104 contains the mappings from the Virtual Table back to SalesForce®. Similarly, Map3 106 contains the mappings from the Virtual Table back to SQL. Each map provides a logical association between the sources and some other schema—in this case a Virtual Table. Therefore, the lines between the sources and the Virtual Table represent the logical association between the source data and the Virtual Table.

With reference to Map2 104 and Map3 106, one can see that a single field in the virtual table (Customer_Account_Number) can update multiple disparate sources (CustAcctNum) in both the SalesForce® and SQL). This means when an update, create, or delete method is desired, the Customer_Account_Number field in the Virtual Table is used to indicate the appropriate record in both SalesForce® and SQL for the update.

Referring now to FIG. 3b which depicts a more generalized view of Operation metadata. The destination schema is defined by the virtual template in the read operation map. Read operations 114 are executed via the maps 116. Read operations 114 always have a single map but can have multiple source templates. Update operations 118 can have one or more maps 116. Typically, there is one map 116 for each source to be updated. Update operations 118 can be configured to update one or more sources by selecting an update map 116 for each source desired. Update can be made to endpoints that are not sources by selecting maps with appropriate logic and templates. When an update is triggered by interaction with the virtual table (e.g. an end user updated a field/value on the screen), the update will be executed.

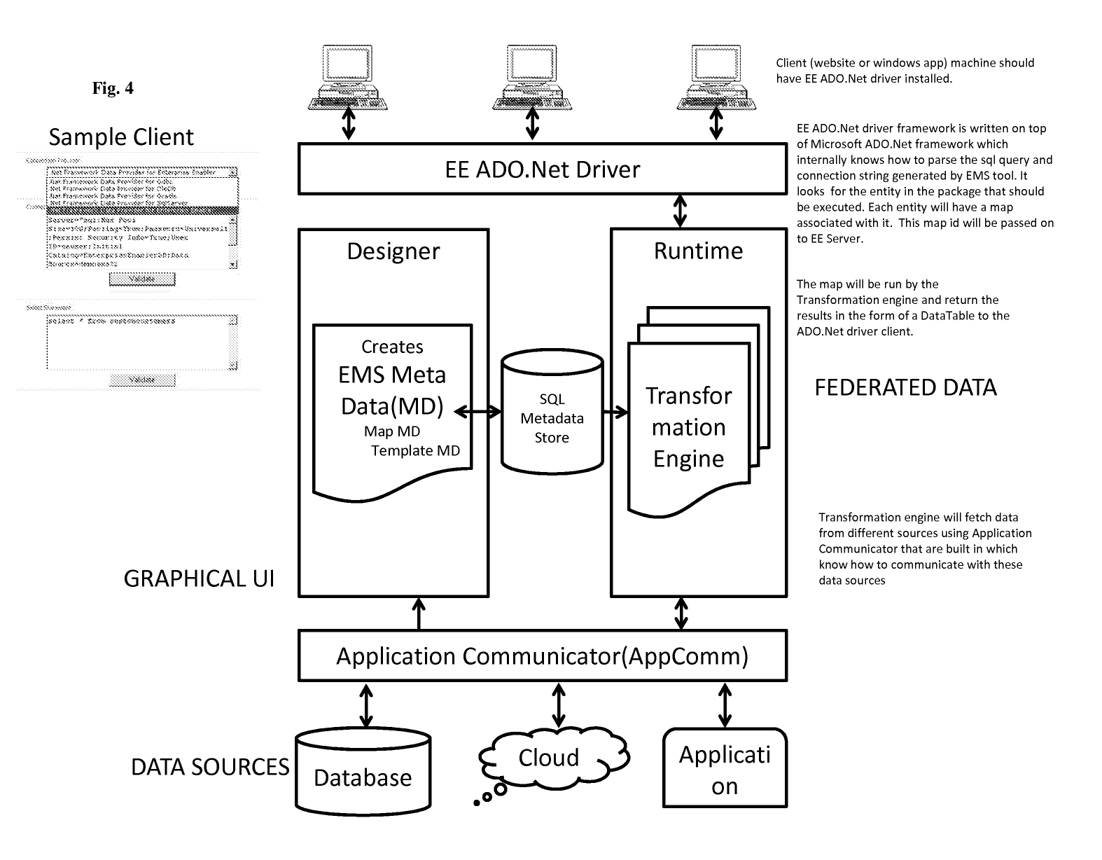

FIG. 4 depicts a screenshot of the main interface of an embodiment according to the disclosed subject matter. The main interface of the graphical user interface provides the user access to all pertinent portions of the system. The Name field 122 allows the user to provide a unique name for the particular Container definition. The Entities field 124 allows the user to select from a list of predefined maps 116 or predefined source templates. The first selection is generally the map 116 for the required read Operation. In the case of selecting a source template rather than a pre-built map 116, the map 116 will be automatically generated and saved in the Operations metadata. In the case where a map 116 is selected, Entity name will be auto selected from the virtual destination template, and if the user so chooses, read, create, update and delete operations are created automatically according to the requirements of the integration platform. The only required operation is read, but create, update, and delete are also available.

As discussed earlier, the Entity contains information on associations between one or more data sources and a destination. These data sources could be disparate (i.e. incompatible with each other). In one embodiment, the Entity contains one or more Operations defining mapping from the data sources to the destination's virtual schema. Each mapping represents a path for an operation on the Entity.

Once the Entity name is added, the user selects the method or operation 126. These operations could be read, create, update, and/or delete (note: as discussed previously the only required method/operation is read). Other operations can easily be incorporated.

For example, if the user only wished to read the data from the source and display it in the destination, then the user would select read and the read map would be selected. However, if the user wanted to also permit updating of the source, then a two way map is required. If the update map was not previously created, the disclosed subject matter can automatically create the update map and add it to the Entity. Additionally, because the update map may have a one-to-many relationship (e.g. if there are multiple sources), the user may select one or more of the sources to be updated in the map field 128.

Then the user could select filters 130. Filters 130 permit the end user to filter the data presented in the destination by one or more of the selected filters 130. For example, if the user wanted to allow filtering on UserName, the user would only need to include “UserName” in the filters field. UserName would be passed through to the integration platform on a Read. In another example, if the user wanted to permit filtering on “PriceOfItem”, the user could also add “PriceOfItem” to the filters field. In this example, the end user accessing the destination program could then include, for example, only customers whose last purchase included an item in excess of $10.00.

Associations 132, allows users to create associations between multiple Entities. This is used for creating relationships across source applications with primary key and foreign key relationship.

The ADO.Net 134, SharePoint® 2007/2010—Generate XML 136, SharePoint® 2010—Deploy 137, and Web Services 138 buttons automatically, without additional user interaction, trigger the Packaging executable to generate the instructions and/or executable module 88 necessary to enable the disclosed subject matter. For example, after the user has defined the entity, if the user's destination was SharePoint® 2007, the user need only click the Generate XML button 136 and the disclosed subject matter creates the requisite XML file such that SharePoint®, via a custom connector, will properly display the aggregated data and will enable the method (e.g. read, create, update, delete). If the user later wanted to implement the entity as a web service, the user need only click the web service button 138 and the executable module 88, including the infrastructure necessary for the web service is created including a new process to host the web service and proxy assemblies to receive and send data in a web standard format. In another example, the user could click the ADO.Net button 134 to create the executable module 88 containing the connection string required by the ADO.Net driver to properly provide the aggregated data and implement the desired method/operation to the destination system.

The disclosed subject matter internally creates Entity Container metadata in Metadata Generator 74, based on Operation metadata 78 created by an integration platform. The disclosed subject matter intelligently finds all the fields, key information, read only fields, SharePoint specific fields etc. . . . on the Operation metadata 78. Later the disclosed subject matter encapsulates this metadata into an Entity metadata 94. Container metadata 96 also encapsulates security, filters and caching.

Security can be applied in different ways. The security allows a user to save application credentials in Secure Store Service or any other Single Sign On databases. In one embodiment security tokens are used to authenticate and authorize. The security also allows users to utilize Active Directory Security.

When a Filter is added, a new column or columns are added as input to get only specific rows based on the filter condition. The caching setting allows caching of data at specified periods of time. Single or multiple Entity metadata sections are combined to create a unique Container. If multiple Entity metadata sections are created, associations can be created among these multiple Entity metadata sections. Associations allow Entities to be related by key column information in the primary entity and normal column in the secondary entity.

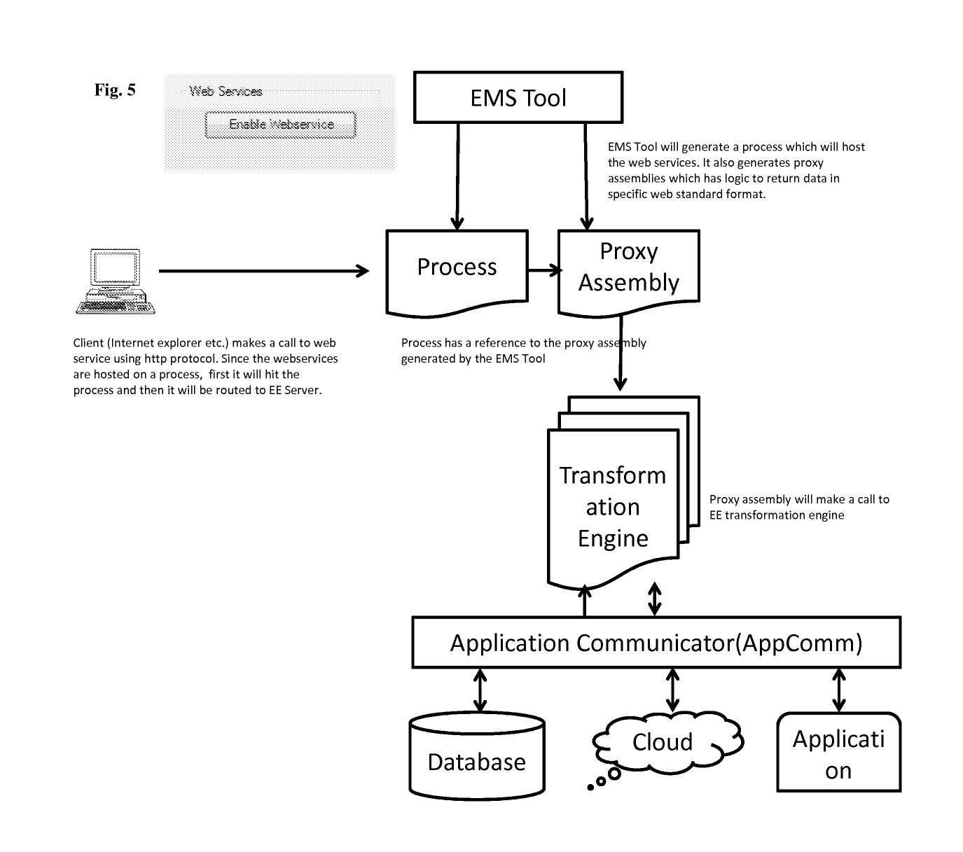

FIGS. 5a through 5d depict screenshots of an embodiment of several input boxes (select map, add association, connection string, and add filter) reached from the main interface according to the disclosed subject matter. Where an embodiment includes additional modes of delivery that offer additional functionality or require additional information from the user, there may be additional input boxes to capture the relevant information. FIG. 5a shows the pop-up permitting the user to either select an existing Operation map or let the disclosed subject matter automatically generate the update map (as discussed earlier). If the map is to be generated from a source template, a one-to-one map will be generated for each operation, and the metadata will be stored in the Operation Metadata store according to the requirements of the integration platform. FIG. 5b shows the pop-up permitting a user to create an association between different entities. FIG. 5c shows the custom connection string the disclosed subject matter created from the Packaging generator 82 portion of Metadata Generator 74 after the user configured the Container definition (see FIG. 4) and clicked the ADO.Net button 134. Finally, FIG. 5d shows the Add Filter pop-up allowing the user to define what fields the end user may filter on when the data is presented in the destination system. This information will be passed through to the integration platform in the manner required by the integration platform.

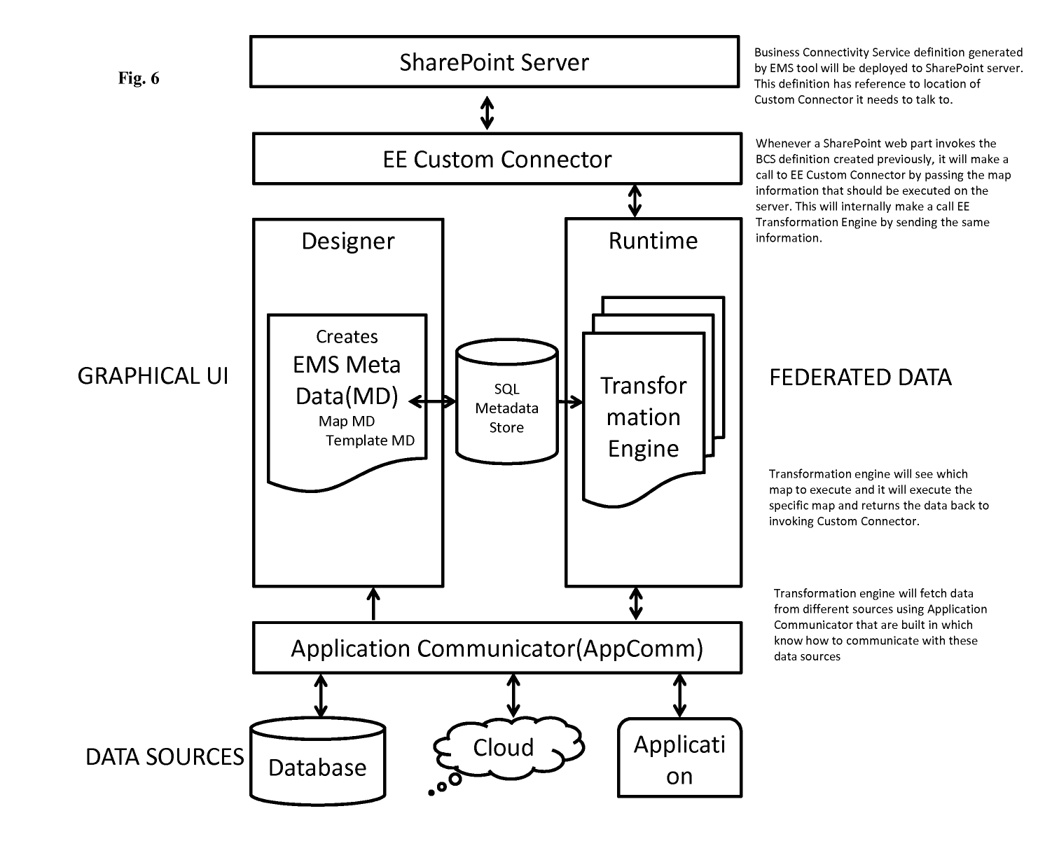

FIG. 6 depicts a block diagram for implementing the disclosed subject matter for ADO.Net according to a particular embodiment of the disclosed subject matter. A custom ADO.Net driver 160 is installed on client machines 162. The custom ADO.Net driver 160 is written on top of the Microsoft® ADO.Net framework and enables the parsing of the connection string discussed earlier to provide the aggregated data to the client and to pass queries to the ADO.Net Engine 164. The ADO.Net Engine 164 parses the query to find the Entity which should be executed, along with the operation, filters, etc. Then the ADO.Net Engine 164 looks up the appropriate map id and passes the map id to the ADO.Net Operation Executor 166. The map id is just a reference or pointer to the particular map or metadata to be executed. For a Read, The ADO.Net Operation Executor sends the map id to the integration platform 168, which in turn executes the data operation and returns the results in the form of a DataTable (i.e. virtual table) which is sent back to the ADO.Net Engine by the ADO.Net operation executor. Finally, it is passed to the Custom ADO.Net driver which presents it to client 162.

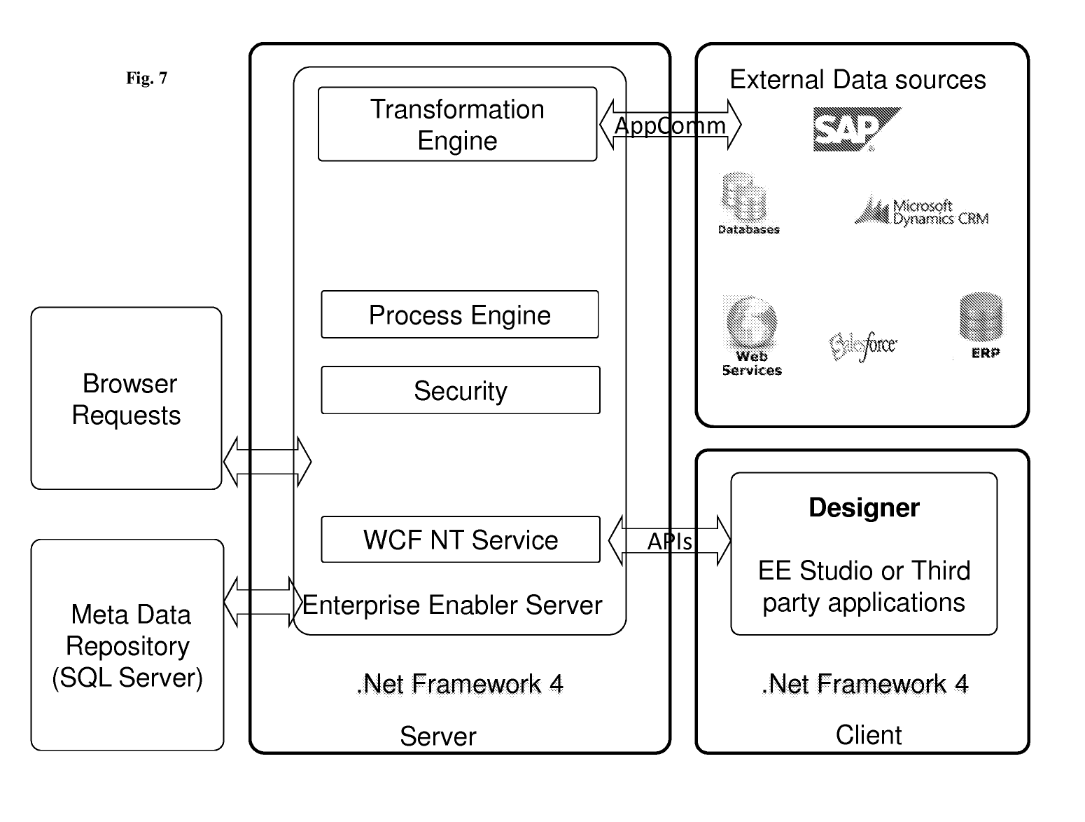

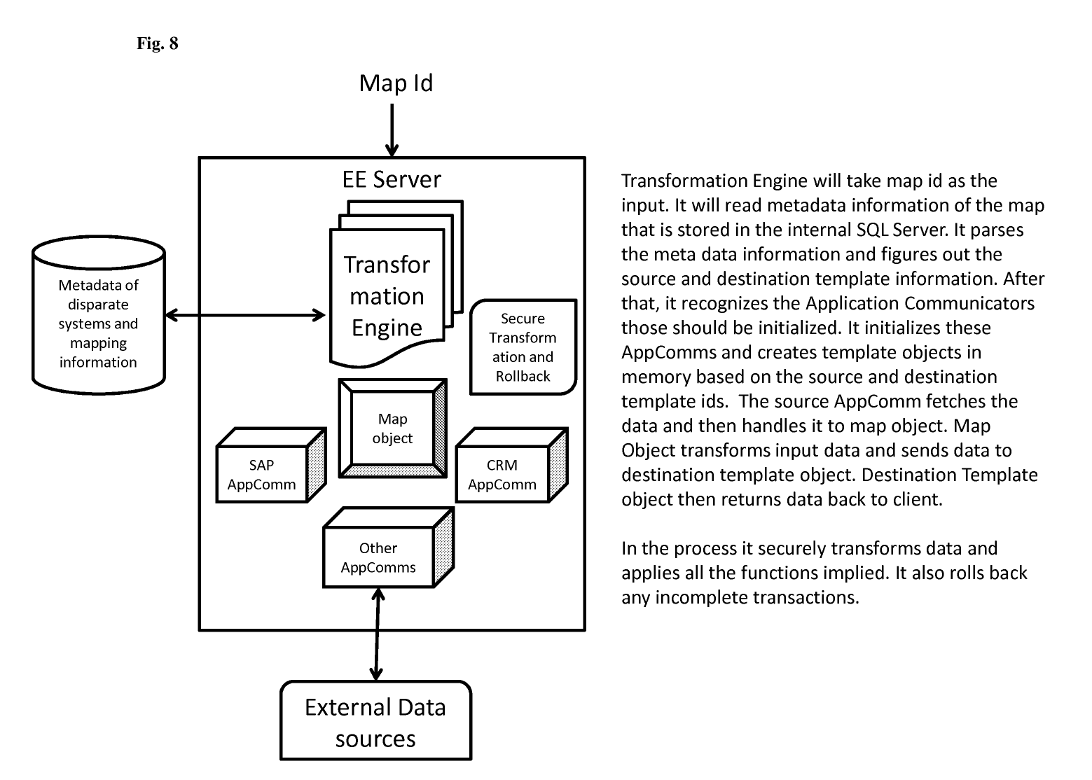

FIG. 7 depicts a block diagram for implementing the disclosed subject matter for web services according to a particular embodiment of the disclosed subject matter. When a client 188 makes a call to web services (for example through a web browser), the process 184 which hosts the web service, receives the call. The Web Service Host 184 will try to find Methods metadata assembly 186 to invoke the specific method based on the request. If the correct methods metadata assembly is not present, then it will be created according to methods metadata found in EMS metadata. A Methods metadata assembly contains methods, information of the map id to be executed, and other information. Based on the request made, the correct method will be executed. This will pass the map id to the integration platform, which in turn executes the map and returns the data in the form of a DataTable (i.e. virtual table). For web service, the DataTable (i.e. virtual table) must be formatted in a manner that the web service can understand. Therefore, the aggregated information is passed to a Methods metadata assembly 186. The Methods metadata assembly 186 converts the aggregated information into a web standard format and then provides the web standardized aggregated data to the web service host 184 for delivery to the client 188.

FIG. 8 depicts a block diagram for implementing the disclosed subject matter for SharePoint® according to a particular embodiment of the disclosed subject matter. The XML Business Connectivity Service (“BCS”) definition, which was generated by the User Interface 136, should already be deployed to the SharePoint® server 202. That definition has a reference to a custom connector 204 which also must be installed on the SharePoint Server. Whenever a SharePoint® web part, or any custom web part, invokes the BCS definition, SharePoint® makes a call to the custom connector and passes the entity information to be executed. Custom connector passes the information to the Operation executor 206 which constructs the instructions to send to the integration platform 186. The integration platform 16 then aggregates the requested information as previously discussed and invokes the custom connector 204 to pass the information back to SharePoint® 202.

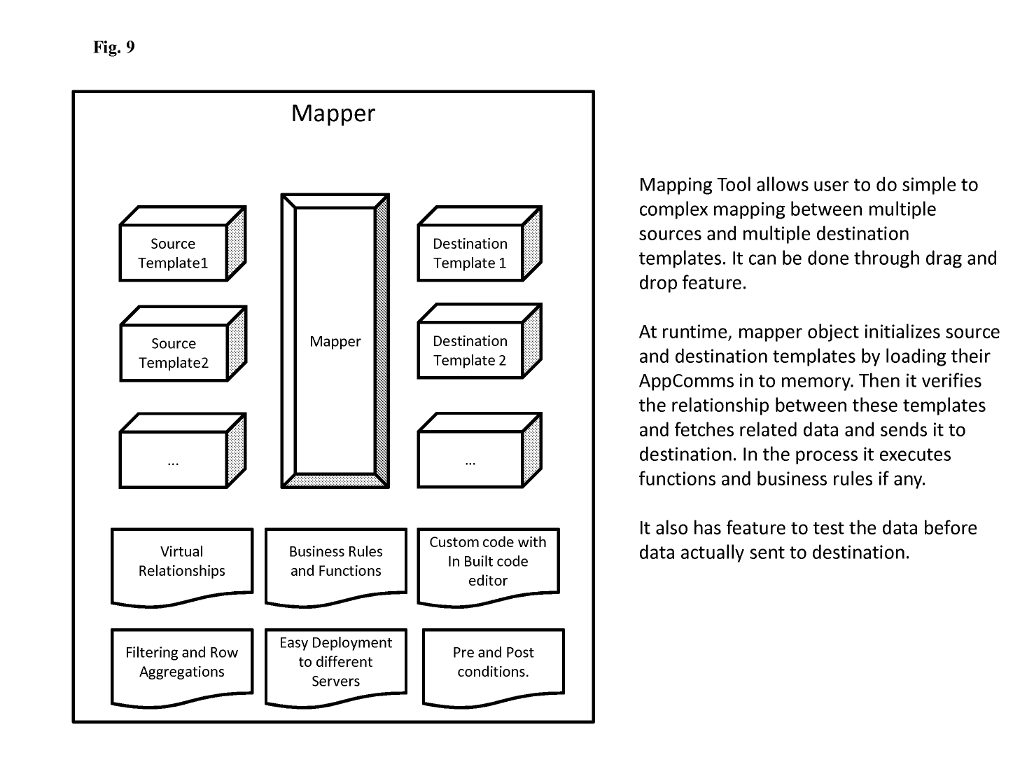

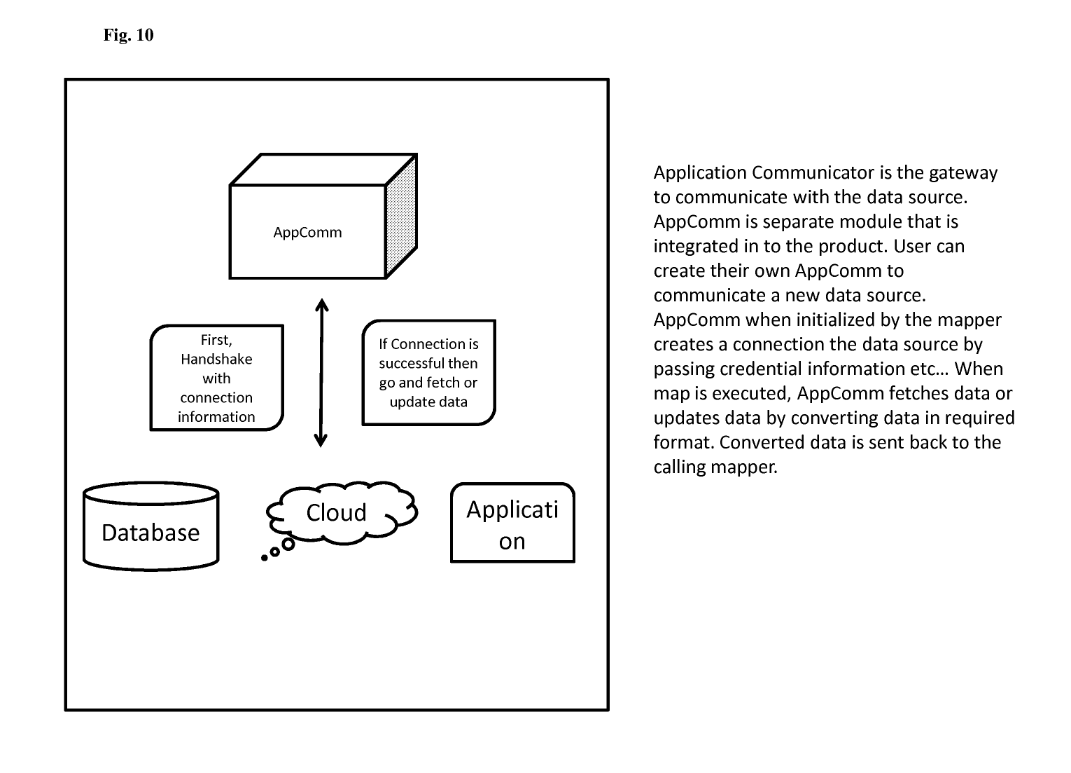

FIG. 9 depicts a block diagram of an integration platform that interacts with the disclosed subject matter according to a particular embodiment. The previously discussed Operation metadata (e.g. source, map, destination, in one embodiment, is stored in a SQL database 232. The integration platform's server has access to this SQL database 232 so that the metadata contained in the Entity can be loaded in response to a request. As discussed earlier, this request could be made from ADO.Net, SharePoint®, and/or web services (or another destination system). The Operation metadata is passed to the federation and transformation engine 222 which reads, updates, creates, and/or deletes information from the external data sources 236 via the application communicator. The external data sources 236 are synonymous with the source systems (e.g. SAP, Microsoft Dynamics CRM, Salesforce®, ERP, etc.). For example, on a read operation, the application connector retrieves information from one or more of the external data sources 236 and provides the information to the federation and transformation engine 222. The transformation engine 222 collects the retrieved data and passes a virtual table (e.g. DataTable) to the requestor. For an update operation, the requestor passes the updated data to the federation and transformation engine 222 which determines which external data sources are to be updated and passes the requisite information to the application connector. When the application connector receives the updated information along with the source field(s) to be updated from the transformation engine 222, the application connector writes the updated data directly to the external data source 236.

From a higher level, the federation and transformation engine 222 is a part of the enterprise enabler server which also includes other components such as a data workflow engine 224, security handler 228, data quality handler 226, Big Data utilities and others.

As can be appreciated, the disclosed subject matter provides a significant improvement over current technologies and processes. As a brief summary, with the disclosed subject matter there is no need for domain expertise because the required metadata, including schema and sources of the data are already defined by metadata from the integration platform. Update, create, and delete maps can be created automatically from the read map. The underlying integration platform (FIG. 9) already knows the best way to communicate with the different and potentially disparate data sources. Users can create maps via an intuitive GUI. Additionally, exposing the retrieved data in several different destination systems (e.g. SalesForce®, ADO.Net, web service) 284 is predominantly a single click process. Finally, if the data source schema changes, the user can quickly and easily refresh the template, update the map, and expose the data for the desired destination system.

Although discussed with particular emphasis towards ADO.Net, SharePoint®, and a web service, one skilled in the art, with this disclosure, could implement the disclosed subject matter for other destination systems.

Although example diagrams to implement the elements of the disclosed subject matter have been provided, one skilled in the art, using this disclosure, could develop additional hardware and/or software to practice the disclosed subject matter and each is intended to be included herein. The particular embodiments provided herein are not to be considered limiting in any manner and are only examples of particular ways to use and/or make the disclosed subject matter.

In addition to the above described embodiments, those skilled in the art will appreciate that this disclosure has application in a variety of arts and situations and this disclosure is intended to include the same.

What is claimed is:

1. A method, the method comprising the following steps:
receiving operational metadata from an integration platform, said operational metadata including associations between one or more sources of data and a virtual table, wherein said sources of data may be disparate from one another;
identifying fields, key information, read only fields, and any endpoint application specific fields and/or mode specific fields on said virtual table;
generating entity metadata, said entity metadata including data filtering options, security provisions, and/or special handling instructions one or more of which may be unique to a particular user or one or more of said sources;
generating container metadata, said container metadata including instructions for at least one of said modes to interact with data contained in one or more of said sources of data.

2. The method of claim 1, wherein there are at least two of said sources of data.

3. The method of claim 1, wherein at least two of said sources of data are disparate from one another.

4. The method of claim 1, said sources of data from the list comprising:
database systems;
customer relationship management systems; and
collaboration and document management systems.

5. The method of claim 1, wherein said interaction includes at least read and update capability.

6. The method of claim 1, wherein said security provisions include:
single store security;
claims authorization;
tokens;
active directory security; and/or
single sign on.

7. The method of claim 1, wherein said mode is one of the following:
web service;
ADO.Net; or
Sharepoint®.

8. The method of claim 1, wherein said mode enables bi-directional communication between an endpoint application and said one or more sources.

9. The method of claim 7, wherein said instructions includes generating a business connectivity service definition without additional user interaction wherein said mode is Sharepoint®, wherein said business connectivity service definition is deployed in SharePoint® and enables bi-directional communication between said mode and said one or more sources.

10. The method of claim 7, wherein said instructions includes generating a connection string without additional user interaction where said mode is ADO.Net, wherein said connection string enables bi-directional communication between said mode and said one or more sources.

11. The method of claim 7, wherein said instructions includes generating an executable module without additional user interaction where said mode is web service, wherein said executable module includes a process to host said web service and methods metadata assemblies to enable bi-directional communication between said mode and said one or more sources.

12. The method of claim 1, wherein if said associations are read only associations, automatically creating write associations.

13. The method of claim 1 implemented by a computer.

14. A computer readable medium encoded with a program, the program executing the steps of 1:
receiving operational metadata from an integration platform, said operational metadata including associations between one or more sources of data and a virtual table, wherein said sources of data may be disparate from one another;
identifying fields, key information, read only fields, and any endpoint application specific fields and/or mode specific fields on said virtual table;
generating entity metadata, said entity metadata including data filtering options, security provisions, and/or special handling instructions one or more of which may be unique to a particular user or one or more of said sources;
generating container metadata, said container metadata including instructions for at least one of said modes to interact with data contained in one or more of said sources of data.

15. The method of claim 8, wherein said instructions includes generating a business connectivity service definition without additional user interaction wherein said mode is Sharepoint®, wherein said business connectivity service definition is deployed in SharePoint® and enables bi-directional communication between said mode and said one or more sources.

16. The method of claim 8, wherein said instructions includes generating a connection string without additional user interaction where said mode is ADO.Net, wherein said connection string enables bi-directional communication between said mode and said one or more sources.

17. The method of claim 8, wherein said instructions includes generating an executable module without additional user interaction where said mode is web service, wherein said executable module includes a process to host said web service and methods metadata assemblies to enable bi-directional communication between said mode and said one or more sources.
